(19) United States
(12) Patent Application Publication
(10) Pub. No.: US 2001/0021293 A1
(43) Pub. Date: Sep. 13, 2001

(54) Method for modifying refractive index in optical wave-guide device

(76) Inventors: Hikaru Kouta, Tokyo (JP); Yutaka Urino, Tokyo (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/788,621

(22) Filed: Feb. 21, 2001

(30) Foreign Application Priority Data
Feb. 22, 2000 (JP) 2000-44298

(51) Int. Cl. G02B 6/34

(52) U.S. Cl. 385/37; 385/123; 430/290

(57) ABSTRACT

A method for a method including the steps of: irradiating ultra short pulse laser rays having a pulse width not more than 30 pico-seconds to at least one of a core section and a clad section of an optical wave-guide device to modify a refractive index of the core section and the clad section.

### BACKGROUND OF THE INVENTION

(a) Field of the Invention

The present invention relates to a method for modifying a refractive index of or around a core section for guiding rays, an apparatus therefor, and an optical wave-guide device for modifying the refractive index in accordance with the apparatus.

(b) Description of the Related Art

Optical wave-guides and optical fibers are mainly used for transmitting rays in an optical telecommunication device. The optical wave-guide includes a core section having a relatively higher refractive index and a clad section having a relatively lower refractive index, and the rays are transmitted in the core section having the higher refractive index. The wave-guide having a steep refractive index change at an interface between the core and the clad is referred to as “step-type” and that having a gradual change is referred to as “graded type”. The representative step-type embedded wave-guide can be fabricated by formed a film doped with GeO₂ on a silica-based glass substrate, and making the GeO₂-doped film the ridge-shaped by using photolithography and etching. A ridge-shaped wave-guide or an embedded wave-guide having an internal core section is formed by stacking silica glass and silica-based glass containing the GeO₂ on a substrate.

In recent years, polymer-based wave-guide using a high molecular weight material is researched, and a planer wave-guide is made by binding two films having different diffractive indices followed by a similar process to that for the glass-based wave-guide (refer to, for example, JP-A-10(1998)-268152). Ions are diffused in glass to increase a refractive index in the diffused area to form a graded wave-guide therein. For example, Na⁺ in the glass substrate is replaced with Ag⁺ to elevate the refractive index to form the wave-guide.

In the optical fiber, silica glass doped with the GeO₂ and silica glass are usually used as a core material and a clad, respectively. Plastic fibers are also available in which cores are formed by changing the polymerization degree of the plastic. JP-A-9(1997)-311237 describes that a wave-guide is directly formed in the glass substrate by focusing, in the glass substrate, pulse laser rays having a wavelength transparent to a glass substrate, a peak power of 105 W/cm2 or more, and a repetition frequency of 10 kHz or more, followed by scanning, thereby continuously changing the refractive index of a portion on which the laser beams are focused.

In order to increase the telecommunication capacity of the wave-guide employing the optical wave-guides and the optical fibers, an array wave-guide grating, in addition to an interference filter, a wavelength divider and a directional connector, is developed in which rays having a plurality of wavelengths are guided in a single wave-guide and a specified wavelength is selected. These wave-guide devices require strict control of the refractive index of the wave-guide because the device utilizes the interference and the diffraction of rays. However, in the above-described method, the sufficient control of the refractive index for obtaining target performance of the optical wave-guide device can be hardly performed.

In order to satisfy the specification of the target optical wave-guide device, JP-A-2000-162453 describes that ultraviolet laser rays generated by using an excimer laser are irradiated on a core section in which the rays of the optical wave-guide are transmitted, thereby increasing the refractive index for modification. This method is only effective when the germanium oxide (GeO₂) is doped in the silica glass ion the core section the rays are guided. The reason thereof is the increase of refractive index due to the formation of a GeE′ center related with Ge ion in the glass, and the higher density generated by the structural change related with the Ge [Niishi and Nomura, Oyoo Butsuri (Applied Physics) vol.68, pp.1140 to 1143, 1999].

The method for modifying the refractive index of the silica glass wave-guide doped with the GeO₂ by using the ultraviolet excimer laser rays includes several problems.

A first problem is that a longer period of time is necessary for changing the refractive index. Even if an ArF excimer laser (wavelength: 193 nm, pulse energy: 60 mJ, and repetition frequency: 100 Hz) generating ultraviolet rays having higher output is used, about 20 minutes are required for changing the refractive index by 0.001.

A second problem is that the refractive index can be changed by about 0.001 at maximum because, even if the ultraviolet laser rays are irradiated for a linger period of time, the laser rays having a power density not more than an abrasion threshold of a wave-guide material must be irradiated. Accordingly, the modification of the refractive index to a larger extent is quite difficult by means of the irradiation of the ultraviolet rays.

A third problem is that electrons generated by the ultraviolet rays accompanied by the change of the refractive index is trapped in a defect related with the Ge, and are released from the trap, and the released electrons gradually allow the modified refractive index to return to its original one when the optical wave-guide device after the modification is heated. In other words, the part having the modified refractive index is thermally unstable, and the optical wave-guide device after the modification of the refractive index cannot be subjected to a higher temperature process, or the reliability to temperature is low.

A fourth problem is that the doping of the glass with the GeO₂ is indispensable for changing the refractive index. When the ultraviolet rays are irradiated to the optical wave-guide or the optical fibers made of glass containing no GeO₂, the modification of the refractive index cannot be achieved. Another effective means is not developed.

A fifth problem is that when the excimer laser is used for the ultraviolet laser source, due to the inferior focusing ability of the excimer laser rays, beams cannot be focused to a width about between 5 and 10 μm equal to the width of the core section of the wave-guide in which the refractive index is desirably modified. Accordingly, a mask is necessary for exposing the portion in which the modification is required. However, when the wave-guide interval of the optical wave-guide device is narrower than 30 μm, the individual modification for each of the optical wave-guides is quite difficult even by using the mask.

A sixth problem is that when the excimer laser is used for the ultraviolet laser source, a running cost for changing gas for emitting laser rays is high, the apparatus is expensive and bulky to occupy a larger area. Although the fourth higher harmonic having a wavelength of 266 nm in the rays having a wavelength of 1064 nm emitted from the Nd:YAG laser is possibly used as the ultraviolet laser source for modifying the refractive index in place of the excimer laser, the possibility of generating the GeE′ for changing the refractive index is quite small at 266 nm. If the laser rays are focused on the core section, the change of the refractive index requires a longer period of time, thereby providing no or little practical value.

A seventh problem is that when the refractive index of the glass doped with the GeO₂, is changed by irradiating the excimer laser rays, the temperature is elevated because a part of the laser rays are absorbed in the glass. The elevation of the temperature changes the refractive index of the glass doped with the GeO₂, and the temperature of the device is cooled to an ambient temperature for measuring the device characteristics after the modification. Accordingly, the device characteristics cannot be measured simultaneously with the modification.

### SUMMARY OF THE INVENTION

In view of the foregoing, an object of the present invention is to provide a method for modifying, with higher accuracy, refractive index of a core section of an optical wave-guide device to improve the device characteristics thereof including long-term reliability.

Thus, the present invention provides, in a first aspect thereof, a method including the steps of: irradiating ultra short pulse laser rays having a pulse width not more than 30 pico-seconds to at least one of a core section and a clad section of an optical wave-guide device to modify a refractive index of the core section and the clad section.

The present invention provides, in a second aspect thereof, an apparatus for modifying a refractive index of an optical wave-guide device in accordance with the method of claim 1 including: a stage section for holding and moving the optical wave-guide device in “x”, “y” and “z” directions mounted in a chamber; a lasing section for emitting laser rays having a pulse width not more than 30 pico-seconds used for modifying the refractive index of a core section mounted in the chamber; and an optical system section for irradiating the laser rays lased in the lasing section on the core section of the optical wave-guide device in “x”, “y” and “z” directions mounted in the chamber.

In accordance with the present invention, the refractive index of the core section for guiding the rays of the optical wave-guide device can be modified with higher accuracy, thereby providing the optical wave-guide device having the higher reliability and the higher performance.

The optical wave-guide device of which the refractive index is modified in accordance with the present invention can be applied to the optical telecommunication system, thereby realizing the high-speed telecommunication with the higher capacity and the higher reliability to significantly contribute the development of the information and telecommunication industry.

The above and other objects, features and advantages of the present invention will be more apparent from the following description.

### BRIEF DESCRIPTION OF DRAWINGS

FIG. 1 is a perspective view showing an embedded optical wave-guide for illustrating a method for modifying the refractive index of a core section of an optical wave-guide device by using ultra short pulse laser rays.

FIG. 2 is a diagram showing band-gaps of silica glass and silica glass doped with GeO₂, and the absorption of rays having the respective wavelengths.

FIG. 3 is a sectional view of the optical wave-guide device showing the region in which the wavelength of the ultra short pulse laser ray and the refractive index are changed.

FIG. 4 is a sectional view of the optical wave-guide device showing the modification of the refractive index of the region including the periphery of the core section.

FIG. 5 is a graph showing the changes of the optical path lengths by the scanning distance and the number of the scanning of the ultra short pulse laser rays when the modification is conducted under the conditions of Example 1.

FIG. 6 is a sectional view of the optical wave-guide device of three stacked layers showing the modification of the refractive index of core section of the lower layer of the optical wave-guide device three-dimensionally formed.

FIG. 7 is a schematic top plan view of the optical wave-guide showing the core section of the optical wave-guide in which the refractive index is changed.

FIG. 8 is a schematic view showing the core section having the spherical hole and the core section having the oval hole in the left-hand side and the right-hand side, respectively.

FIG. 9 is a band-gap diagram for illustrating a defective band.

FIG. 10 is a schematic view showing the apparatus for modifying the refractive index.

FIG. 11 is a schematic view showing configuration of a Mach-Zender-type interference filter including a clad section.

FIG. 12 is a schematic view showing the optical wave-guide device in which the refractive index of the core section is modified with the ultra short pulse laser rays.

FIG. 13 is a schematic view showing the optical wave-guide device in which the refractive index of the core section doped with GeO₂ is modified with the ultra short pulse laser rays.

FIG. 14 is a perspective view showing the optical wave-guide device in which the refractive indices of the core section are individually modified.

FIG. 15 is a perspective view showing the optical wave-guide device in which the refractive indices of the core section of the optical wave-guide directly depicted are modified.

FIG. 16 is a schematic sectional view showing the optical wave-guide device having a tapered portion at the input and output portion of the core section.

FIG. 17 includes a top plan view showing a T-shaped branched optical wave-guide device using grating of holes and an enlarged perspective view showing a portion where a refractive index is modified.

FIG. 18 is a sectional view showing the optical wave-guide device in which a reflection occurs in the top part thereof.

### PREFERRED EMBODIMENTS OF THE INVENTION

At first, principles of the present invention will be described for a purpose of clear understanding.

When the ultra short pulse laser rays having the pulse width of 30 pico-seconds or less are irradiated to the region including the core section of the optical wave-guide device formed in accordance with the conventional technique, multi-photon absorption occurs due to the higher energy density, and the optical energy is at first absorbed by electrons. Thereafter, the thermal energy moves from the hot electrons to gratings to heat the material.

When the pulse width is 30 pico-seconds or less, the irradiation of the pulse finishes in almost all the materials before all the energy of the hot electrons moves to the gratings or immediately after the completion of the movement. Accordingly, the electron temperature and the grating temperature are not equilibrated with each other. In this case, the diffusion of the energy of the laser rays to outside of the focused portion is suppressed, and the laser rays locally heat the focused portion. When the energy density of the rays locally absorbed in the portion exceeds the limit for degenerating the materials forming the core material, the bonding states among the atoms and the molecules constituting the core material are changed to take place evaporation, melting, degeneration and thermal expansion, resulting in the rapid increase of the inner pressure of the localized portion. Thereafter, the core material is cooled, and when the structure is rearranged, the density of the structure is higher than that before the irradiation. The higher density increases the refractive index. Although the density of the periphery of the higher density portion is lowered, the change of the refractive index is quite small because the surface area of the periphery is large.

When the power density of the on the focused portion largely exceeds the abrasion threshold of the core material, the material existing on the central part of the focused portion enters under the surrounding material to reduce the density of the central part. The central part is depleted when the energy further increases. The refractive index is lowered when the density is reduced, and when depleted, the refractive index is 1.0. Although the density of a specified part around the lower density part or the depleted part increases, the change of the refractive index is quite small because the surface area of the part is large.

Based on the above principle, the amount of the change of the refractive index of the higher density portion or the lower density portion can be controlled by the optical energy of the pulse laser rays, the pulse repetition frequency, the irradiation time, the number of the pulses and the scanning speed. The degeneration threshold of the core section of the optical wave-guide depends on the kind of the core material. By controlling the irradiation conditions, the thermal treatment with heat generated by the refractive index change can be conducted together with the change of the refractive index. The color center unstable to the heat generated by the refractive index change can be removed by the heat.

The energy of the laser rays irradiated by using the ultra short pulse laser having the pulse width of 30 pico-seconds for changing the refractive index of the optical wave-guide is required to be smaller than the band-gap energy of the clad material for preventing the absorption of the laser rays into the clad material.

However, even if the energy of the laser rays is smaller than the band-gap energy, the multi-photon absorption occurs at the higher energy density and the surface may be subjected to abrasion. In order to prevent the occurrence, the energy of the laser rays is allowed to be one-third or less the band-gap energy such that the absorption occurs only in the three-photon process. As a result, the surface abrasion is suppressed when the ultra short pulse laser rays are focused and irradiated on the device, and the multi-photon absorption is allowed to take place only in the core region where the rays are focused in the device, thereby changing the refractive index. The size of the region in which the refractive index changes can be easily controlled by adjusting the power of the laser rays.

When the ultra short pulse laser rays having the pulse width of 30 pico-seconds are irradiated to the core section made of the glass doped with the GeO₂, the refractive index can be changed, because of the effect of the multi-photon absorption, by the structural change of the glass related with GeO₂ similarly to the case when the rays having the wavelengths of 193 nm and 248 nm of the ArF and KrF excimer lasers are irradiated.

Since beams can be focused in case of the ultra short pulse laser different from the excimer laser, the laser beams can be controlled along the core section without the mask. Since the irradiation at the higher energy density can be conducted only on the core section, the change of the refractive index can be saturated.

When the pulse laser rays is irradiated having the energy density higher than that required for the saturation of the refractive index change, the strict control of the optical path of the wave-guide can be performed by changing the length of the wave-guide core for changing the refractive index. The simultaneous irradiation and thermal treatment resolve the problem regarding the refractive index change due to the heat by the excimer laser. Accordingly, the modification and the adjustment of the refractive index with higher accuracy can be conducted.

When the beams having the Gaussian-like strength profile are used as the pulse laser rays, the beams are focused to an extent the diffraction of the rays occurs, and the portion in which the refractive index is changed may be lower than the diffraction limit. Accordingly, when the wave-guide interval is 30 μm or less, each of the wave-guides can be modified individually.

A probability of the refractive index change in the portion where the refractive index is changed in accordance with the present invention may exist, depending on the material of the wave-guide core, caused by the influence of the color center similarly to he case where the ultraviolet rays are irradiated. However, the influence of the color center on the refractive index change can be removed by thermally treating the device to return the electrons trapped in the color center to the valence band even if the color center remains. Only the refractive index change remains modified by the higher density, the lower density and the depletion. Accordingly, the thermal treatment of the optical wave-guide device modified in accordance with the present invention improves the reliability thereof.

The pulse laser rays can be irradiated to the specified core section of the optical wave-guide device without the influence of external vibrations by mounting a laser emitting section for emitting the ultra short pulse laser rays required in the apparatus for modifying the refractive index, an optical system section for leading the laser rays to a specimen and a stage section for holding and moving the optical wave-guide device in “x”, “y”, and “z” directions in a single chamber. The change of the amount of the refractive index can be strictly adjusted to the specified value by binding the optical fibers to the optical wave-guide device in advance, modifying the refractive index while monitoring the device characteristics under the transmission of the rays, and feeding back the detected deviation from the optimum value to the irradiation conditions of the pulse laser rays.

The material which can modify the refractive index by using the higher density, the lower density and the depletion without generating the cracks or deficiencies on the focused portion of the ultra short pulse laser rays having the pulse width of 30 pico-seconds or less includes a glass-like amorphous substance and an organic polymer The glass modified to have the higher density, the lower density and the depletion stably exists up to its glass transition point. The silica glass (SiO2) having a softening point of 1500° C., and the refractive index thereof is not changed in a temperature range between 0 and 100° C., an ordinary circumstance using the optical wave-guide device, thereby improving the reliability of the device to the temperature change. In case of the optical wave-guide made of the polymer material, the refractive index thereof changes by the polymerization degree by the irradiation of the pulse rays and the changes of its structure and composition. The stability of the refractive index to the temperature depends on the composition and the degree of the polymerization of the polymer. A polyimide-based material is stable up to about 200° C. A semiconductive material having an amorphous state other than crystal may be used as the core material of the present invention.

The core diameter of the optical fiber in the single mode is determined by the difference of the refractive indices between the optical fiber and the clad, and the diameter thereof currently used is about 7 to 10 μm. The bonding between the optical fibers and the optical wave-guide device can be conducted without loss by adjusting the core diameter of the optical wave-guide similar to the diameter of the optical fiber. However, the reduced diameter may be preferable for integrating the optical wave-guide devices or for suppressing the transmission loss.

The input and output of the optical fibers can be bonded to the core section of the device narrower than the core diameter of the fiber, by increasing the refractive index of the clad section including the cores of the input and output end surfaces of the optical wave-guide device by using the ultra short pulse laser for forming the tapered cores on the input and output end surfaces.

The core of the optical wave-guide is depleted by using the ultra short pulse laser, then the refractive index is 1.0, thereby increasing the difference of the refractive indices between the core and the fiber. The regular arrangement of the depleted portions or the holes in the core can form the grating having an excellent diffraction efficiency. The shape of the hole may be spherical or oval, and by adjusting the irradiation conditions, the bar shaped hole may be possible. The adjustment of the shape and the arrangement may control the wavelength and the direction of the diffracting rays.

The planar wave-guide layer prepared by doping the silica glass, sandwiched by the clad layers, with the GeO₂ is scanned with the pulse laser rays having a pulse width of 20 pico-seconds or less, thereby increasing the refractive index of only the scanned portions, and the channeled wave-guide may be obtained from the planar wave-guide. The rays introduced to the planar wave-guide and transmitting therein are focused to the portion having the higher refractive index to be output from the channeled wave-guide.

Now, the present invention is more specifically described with reference to accompanying drawings.

Embodiment of Method for Modifying Refractive Index

The present Embodiment is an example of modifying a refractive index of an optical wave-guide device of the present invention.

In the present invention, the refractive index of a core section doped with GeO₂ in a clad portion on a silica glass substrate of an embedded optical wave-guide device is modified. While an ultra short pulse laser ray having a pulse width of 30 pico-seconds or less and emitted from a Ti-sapphire laser is focused on the core section, the scanning is conducted along the core section by moving the substrate.

Thereby, the refractive index of the core section is accurately modified in a short period of time to form the core section having the higher refractive index and the higher thermal stability

### EXAMPLE 1

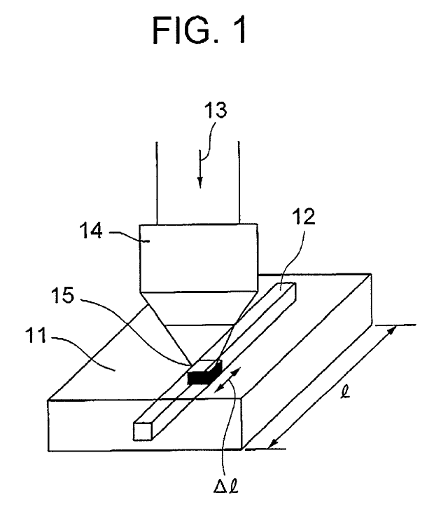

As shown in FIG. 1, an embedded optical wave-guide device includes a core section 12 of an optical wave-guide doped with GeO₂ in a clad portion on a silica glass substrate 11.

The refractive index of the core section of the optical wave-guide device is 1.474, and the geometric length of the optical wave-guide “l” is 30 mm.

Ultra short pulse laser rays 13 having a pulse width of 150 fento-seconds, pulse energy of 0.1 μJ, a pulse repetition frequency of 200 kHz and a wavelength of 800 nm emitted from a Ti-sapphire laser were focused on the core section 12 with a spot diameter of 7 μm similar to a width of a core section of an optical wave-guide by using an objective lens 14, and the scanning was conducted along the core section 12 by moving the substrate for the geometric length “Δl” at a rate of 1 mm/s., thereby modifying the refractive index.

The length “L” of the optical path after the modification of the refractive index is a sum between a product of the refractive index “n” and of the geometric length “Δl” and a product of a changing rate of the refractive index “Δn” and of the geometric length “Δl”, and is expressed by the following equation 1, wherein Δn is a changing rate of a refractive index modified section 15 or of the refractive index of the geometric length “Δl”, L₀ is an optical path length before the modification, and ΔL is an optical path changed by the modification.

$$\begin{matrix}L = n ( 1 - Δ 1 ) + ( n + Δ n ) Δ 1 \\ = n1 + Δ n Δ 1 \\ = {L}_{0} + Δ L\end{matrix} \qquad ( 1 )$$

After a length of 1 mm, as Δl, was scanned by using laser rays, the optical path length “L” was changed from 44.220 mm to 44.222 mm. The scanning by laser rays for the optical length path (Δl) of 2 mm changed the optical path length to 44.224 mm. The increase of every 1 mm of the scanning distance or Δl increased the optical path length by 0.002 mm.

The substitution of the experimental results for the equation (1) revealed that Δn was 0.002 when the modification was conducted at a scanning rate of 1 mm/s under the pulse lasing optical conditions of Example 1 and the change of the refractive index per unit length of the scanning was 0.002/mm.

The change of the refractive index per unit length of the scanning under the same conditions except that the pulse repetition frequency was 100 kHz was 0.001/mm.

After the optical wave-guide device having the modified refractive index was heated to 300° C., and maintained for 24 hours, the wave-guide device was cooled to ambient temperature, the optical path length was again measured to be the same as that before the thermal treatment. The thermal treatment did not change the modified refractive index.

The energy density at the threshold value for changing the refractive index of the core section in the glass by irradiating the laser rays depended on the pulse width, the repetition frequency and the wavelength of the pulse of the laser rays. The experiment of modifying the refractive index was conducted by changing these three parameters similarly to the experiment shown in FIG. 1.

As a result, the amount of the refractive index per unit scanning distance was changed by optimizing the energy density of the pulse by establishing the pulse width, the wavelength and the pulse repetition to be 30 pico-seconds or less, 349 nm or more and 10 kHz or more, respectively. The refractive index of the core section could be modified similarly to the case related with FIG. 1.

Although the minimum pulse width which was confirmed to modify the refractive index was 50 femto-seconds, the modification was considered to be possible at the pulse lower than 50 femto-seconds. Although the maximum wavelength and pulse repetition which were confirmed to modify the refractive index were 1550 am and 200 MHz, respectively, the modification was considered to be possible at the wavelength larger than 1550 am and at the pulse repetition larger than 200 MHz.

### COMPARATIVE EXAMPLE 1

For comparison with Example 1, an irradiation experiment was conducted using a pulse width of 50 pico-seconds different from that of Example 1 and using pulse energy of 0.1 μJ, a pulse repetition frequency of 200 kHz and a wavelength of 800 nm substantially same as those of Example 1. The experiment revealed that the optical path length of the optical wave-guide device was not changed, and the refractive index of the irradiated core section was not changed.

Then, the pulse energy of the laser rays was gradually increased from 0.1 μJ. When the pulse energy reached to 0.7 μJ, the irradiated core section was dielectrically destroyed before the modification of the refractive index. The dielectric destruction refers to destruction in which cracks are generated in a random direction due to the effect of heat.

Then, experiments for modifying the refractive index were conducted similarly to Example 1 while each of the four parameters including the pulse width of the laser rays, the repetition frequency of the pulse, the wavelength and the lasing energy was changed.

When the pulse length was longer than 30 pico-seconds, the core section was dielectrically destroyed before the modification of the refractive index whatever hard the other parameters were optimized.

The refractive index of the core section could be modified by irradiating the ultra short pulse laser rays having the pulse width of 30 pico-seconds or less, and cold not be modified by using the ultra short pulse laser rays having the pulse width over 30 pico-seconds based on the results of Example 1 and Comparative Example 1.

### EXAMPLE 2

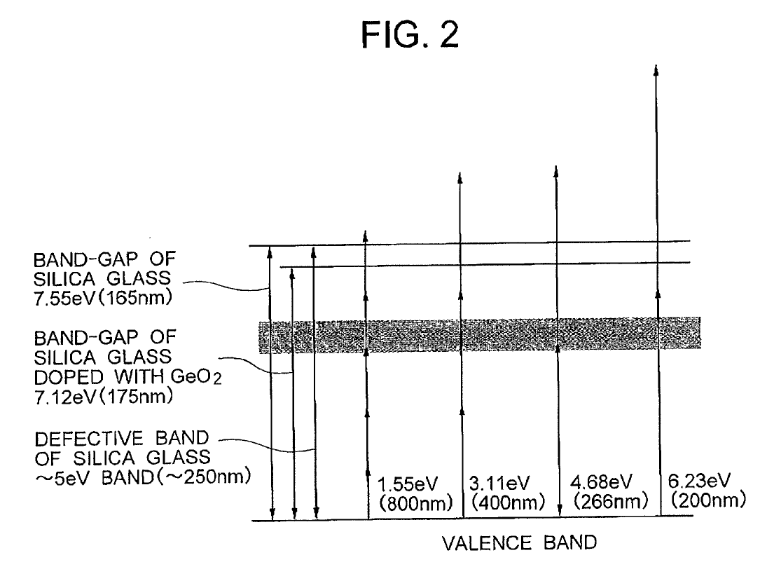

Example 2 is a concrete example of the method of modification described in claim 2. FIG 2 is an absorption spectrum showing band-gap energy of the silica glass forming the clad section and of the silica glass doped with the GeO₂ forming the core section of the optical wave-guide device of Example 1.

As shown therein, the band-gap energies of the non-doped silica glass 16 and of the silica glass 17 doped with the GeO₂ were 7.55 eV (band-gap wavelength of 165 nm) and 7.13 eV (band-gap wavelength of 175 nm), respectively. The silica glass included a defective band near the band-gap energy of 5 eV (250 nm).

The wavelength of laser rays used in Example was 800 nm and the photon energy was 1.55 eV. As shown in FIG. 2, the absorption of the rays did not occur in the two-photon process from a valence band while the absorption occurred in the three-photon process because the rays reached to the defective band.

Since the three-photon process occurred only on the portions where the higher energy density was obtained by focusing the ultra short pulse laser rays, the refractive index was changed only in spherical or oval regions having a focal point with the highest energy density and having a diameter near the beam width or only in the vicinity of the focal point.

An experiment of modifying the refractive index was conducted similarly to Example 1 except that the laser rays emitted by using a non-linear optical element and having the wavelength of 400 nm and the pulse energy of 0.1 μJ which were the second harmonic of the ultra short pulse laser rays having the wavelength of 800 nm used in Example 1 were used.

As shown in FIG. 2, the photon energy of the laser rays having the wavelength of 400 nm was 3.11 eV, which reached to 7.55 eV the band-gap energy of the silica glass in the three-photon absorption and which also reached to 5 eV the band-gap energy of the defective band in the two-photon absorption. Accordingly, the absorption of the rays occurred.

According to the experimental results, since the three-photon absorption and the two-photon absorption occurred only on the vicinity of the focal point of the laser rays similarly to the experiment for the rays having the wavelength of 800 nm, the refractive index of only the portion on the vicinity of the focal point was changed.

The laser rays having the wavelength of 400 nm were more easily absorbed than those having the wavelength of 800 nm, and the change of the refractive index per unit scanning distance was 0.003/mm which was about 1.5 times that for the rays of 800 nm.

The Ti:sapphire laser emitting the pulses of 150 femto-seconds can lase laser rays having a wavelength between 700 and 1000 nm, and can provide the laser rays between 233 and 500 nm by using the second and third harmonics.

The wavelength of the laser rays were gradually shifted to the shorter wavelength side under conditions substantially same as those of Example 1. The laser rays having the energy of 3.56 eV or less (349 nm or more) which was half the band-gap energy of the clad section could change the refractive index. The energy of the above laser rays did not exceed 7.55 eV which was the band-gap energy of the silica glass even if the two-photon absorption occurred. The energy of the laser rays could be absorbed in the vicinity of the focal point by means of the three-photon absorption or the two-photon absorption to the defective band, thereby performing the above change of the refractive index.

### COMPARATIVE EXAMPLE 2

A method of Comparative Example 2 was conducted for comparing the results thereof with those of Example 2.

A third harmonic having a wavelength of 800 nm was obtained by mixing the ultra short pulse laser rays having the wavelength of 800 nm used in Example 1 and laser rays having the wavelength of 400 nm which was a second harmonic. A similar experiment to that of Example 1 was conducted by establishing the pulse energy at 0.1 μJ and using ultra short pulse laser rays having a wavelength of 266 nm and a pulse width of 150 femto-seconds.

As shown in FIG. 2, the photon energy of the rays having the wavelength of 266 nm was 4.68 eV, and exceeded the band-gap of the silica glass in the two-photon absorption. Further, the absorption was observed in the defective band even in the one-photon absorption. Accordingly, the energy was absorbed in all the optical paths of the optical wave-guide device, and the change of the refractive index only of the vicinity of the focal point could not be attained.

Then, the pulse energy of the laser rays was increased. When the pulse energy reached to 1.0 μJ, the focus portion was dielectrically destroyed. A similar experiment was conducted by using rays having the wavelength of 200 nm which was a second harmonic of the rays having the wavelength of 400 nm. Thereby, as shown in FIG. 2, the photon energy was 6.23 eV. Since the photon energy exceeded the absorption by the defective band in the one-photon absorption and the band-gap energy in the two-photon absorption, the rays were absorbed in all the optical paths. Accordingly, similar to the case using the rays of 266 nm, the change of the refractive index of only the vicinity of the focal point could not be attained.

Based on the results of Example 2 and Comparative Example 2, the wavelength of the ultra short pulse laser rays for modifying the refractive index is required to be 349 nm or more.

### EXAMPLE 3

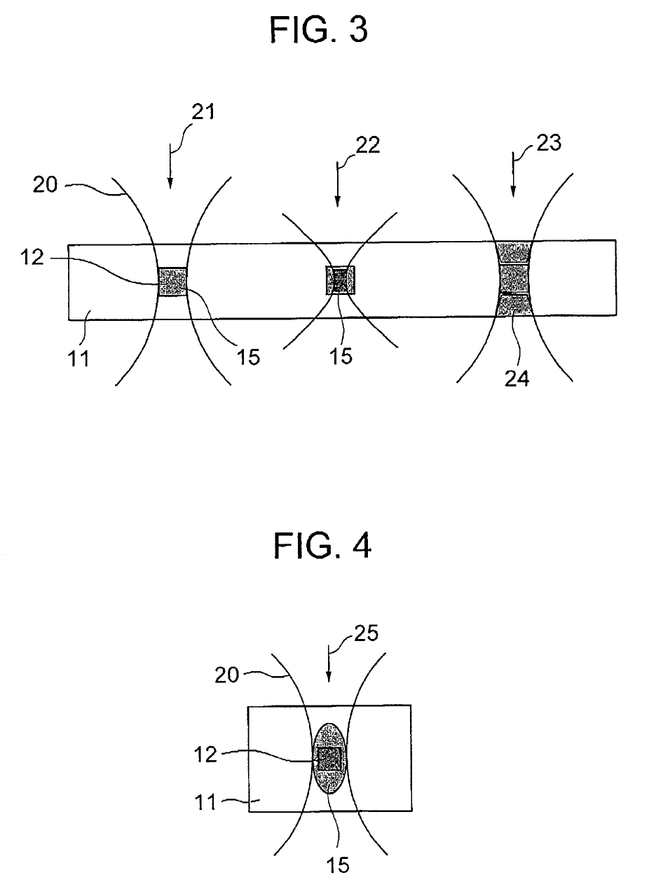

Example 3 is a concrete example of the method of modification described in claim 3. FIG. 3 is a sectional view showing an optical wave-guide device including a core section 12 formed by doping a clad section of a silica glass substrate 11 with GeO₂. The section of the core is 7 μm square. An optical path 20 for focused ultra short pulse laser rays and a portion 15 of which a refractive index is modified are shown in the left-hand side of FIG. 3.

The portion of which a refractive index was modified in accordance with ultra short pulse laser rays having a wavelength of 800 nm focused by using an objective lens of 50 magnifications was only a core section, and a refractive index of a clad section was unchanged.

The refractive index of only part of the core section could be changed, as shown in the central part of FIG. 3, by using ultra short pulse laser rays having a wavelength of 800 nm focused by using an objective lens of 100 magnifications. The permeation loss of the guided rays coming from the wave-guide was within 1%, and the change of the refractive index per unit scanning distance was 0.0010/mm. These were about half the permeation loss and the refractive index change when entirely modified.

Similar experiments conducted by changing wavelengths revealed that, in the wavelength range between 355 and 1000 nm, the refractive index of at least part of the core section could be changed by adjusting the pulse energy density of the laser rays between the threshold value for changing the refractive index of the glass at the respective wavelengths and the threshold value for generating the dielectric destruction.

### COMPARATIVE EXAMPLE 3

A method of Comparative Example 3 was conducted for comparing the results thereof with those of Example 3. An experiment similar to Example 3 was conducted by using ultra short pulse laser rays 23 having a wavelength of 266 nm focused by using an objective lens of 50 magnifications.

As shown in the right-hand side of FIG. 3, since the laser rays were absorbed in the entire optical paths of the ultra short pulse laser rays permeating the optical wave-guide device and the energy could not be concentrated to the focused portion, the refractive index of the core section could not be changed.

Similar experiments conducted by changing wavelengths revealed that, in the wavelength range between 190 and 355 nm, the refractive index could not be changed similarly to the case using the laser rays having the wavelength of 266 nm because the rays were absorbed into the entire optical paths.

Based on the results of Example 3 and Comparative Example 3, the wavelength of the ultra short pulse laser rays for modifying the refractive index of at least part of the core section is required to be 349 nm or more.

### EXAMPLE 4

Example 4 is a concrete example of the method of modification described in claim 4. FIG. 4 is a sectional view showing an optical wave-guide device including a core section 12 formed by doping a clad section of a silica glass substrate 11 with GeO₂. The section of the core is 7 μm square.

The modification of the refractive index was attempted under conditions substantially same as those of Example 1. The region modified by using ultra short pulse laser rays 25 having a wavelength of 800 nm focused by using an objective lens of 20 magnifications was an oval region having a length of 15 μm and a width of 10 μm and including the vicinity of the core section.

The permeation loss of the guided rays coming from the modified wave-guide including the peripheral part of the core section was within 2%, and the change of the refractive index per unit scanning distance was 0.002/mm. These were similar to those when only the core section was modified.

### COMPARATIVE EXAMPLE 4

A method of Comparative Example 4 was conducted for comparing the results thereof with those of Example 4. An experiment similar to Example 4 was conducted by using an objective lens of 10 magnifications. The modified region was an oval region having a length of 30 μm and a width of 10 μm, and the permeation loss after the modification was increased by 5% or more compared with that before the modification.

It is estimated that the increase of the permeation loss of the guided rays in the Comparative Example 4 be caused by the increase of the oval size due to the increase of an incident angle of the laser rays because the objective lens of 10 magnifications was used.

### EXAMPLE 5

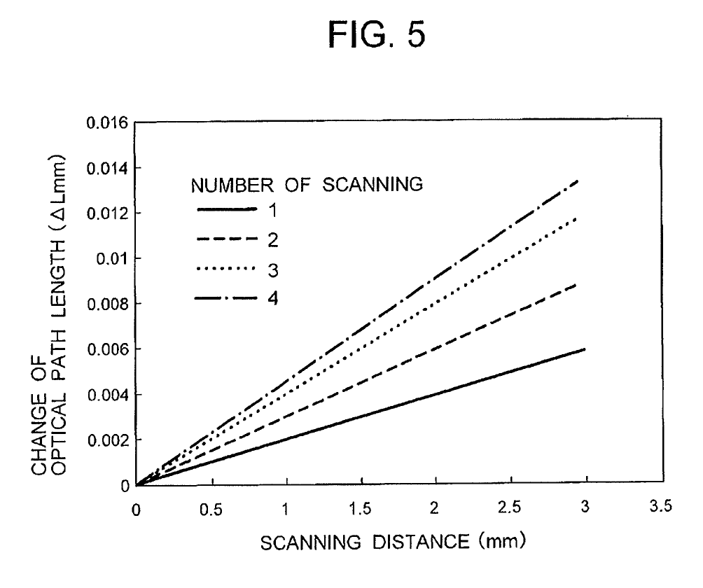

Example 5 is a concrete example of the method of modification described in claim 5. FIG. 5 is a graph showing an influence exerted on the change of the optical path length by the scanning distance and the number of the scannings when the modification of the refractive index was conducted under the conditions of Example 1.

In Example 1, the refractive index was modified by adjusting the change of the refractive index by means of the scanning distance conducted by one scanning of the laser rays along the optical wave-guide. On the other hand, the present Example revealed that the refractive index could be further elevated by twice scanning along the same portion. The refractive index was increased with the number of the scannings, and the change of the refractive index was saturated after the four scannings.

As shown in FIG. 5, the optical path length of the optical wave-guide could be strictly controlled by adjusting the scanning distance and the number of the scannings.

### COMPARATIVE EXAMPLE 5

A method of Comparative Example 5 was conducted for comparing the results thereof with those of Example 5. In the present Comparative Example, the laser rays were continuously irradiated to the region having the diameter about 7 μm without scanning the laser rays, and the refractive index of the core section having the 7 μm square was slightly changed. The continuos irradiation changed the refractive index up to 0.005, and did not further changed the refractive index.

In this case, the changed optical path length “A L” was as follows.

ΔL=Δn×Δl×0.005×0.01=0.00005 mm

This amount was insufficient to modify the optical path length of the optical wave-guide device used in Example.

The present Comparative Example revealed that when the refractive index was modified, the scanning of the laser rays enabled the larger change of the optical path length, and the amount of the optical path length change could be slightly adjusted by changing the number of the number of the scannings.

### EXAMPLE 6

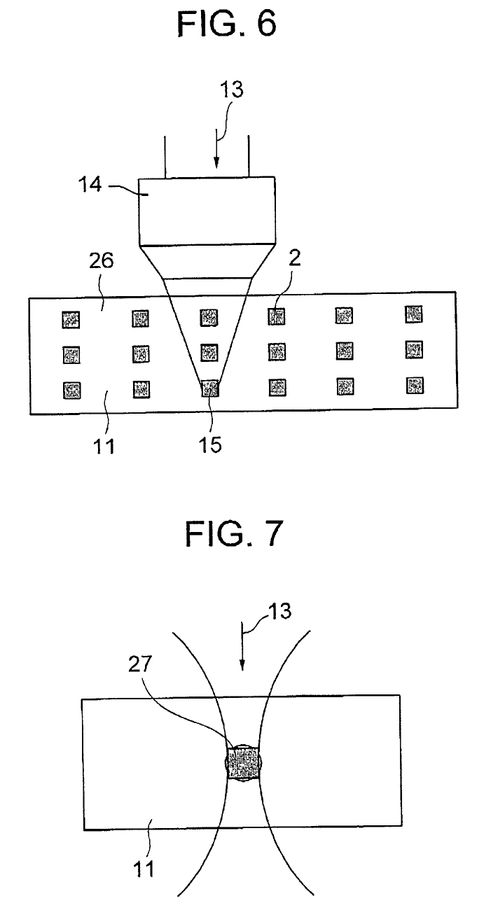

Example 6 is a concrete example of the method of modification described in claim 6. FIG. 6 is a sectional view showing an optical wave-guide device 26 having three optical wave-guide layers stacked with one another.

A clad section included a silica glass substrate 11, and a core section 12 included a silica glass substrate doped with GeO₂ in an optical wave-guide of the present Example. The cross section of the core section was 7×7 μm square, and the space between the adjacent wave-guides was 20 μm.

The distance of 1 mm was scanned at the scanning speed of 1 mm/s along the core section using, as a ray-collecting lens, an objective lens of 50 magnifications under the conditions of Example 1 after the focal point of ultra short pulse laser rays 13 having a pulse width of 150 femto-seconds was focused to the core section of the lowest layer.

The refractive indices of the core section of the first and second layers through which the laser rays permeated were unchanged while the refractive index of the core section of the third layer through which the laser rays permeated could be modified similarly to Example 1.

### COMPARATIVE EXAMPLE 6

A method of Comparative Example 6 was conducted for comparing the results thereof with those of Example 6. An experiment similar to Example 6 was conducted by using an objective lens of 20 magnifications. The modified region was enlarged having a height of 20 μm in a vertical direction, and the refractive indices of the core section of the top portion and of the clad section between the core sections to become the silica glass were also changed in addition to the core section of the bottom layer.

It is estimated that the incident angle of the laser rays was increased by the used of the objective lens of 20 magnifications to provide the results different from those of Example 6.

### EXAMPLE 7

Example 7 is a concrete example of the method of modification described in claim 7. FIG. 7 is a schematic top plan view of an optical wave-guide showing the core section of the optical wave-guide in which the refractive index was changed because of a higher density.

The Raman spectrum of the core section of which the refractive index was modified in Example 1 was measured by microscope analysis. Then, the shift of a peak appeared which corresponded to when the density of the silica glass was made higher by 3%.

The results indicated that the change of the refractive index occurred with the density changed to the higher region of the silica glass. In FIG. 7, the core section 27 of the optical wave-guide having the changed refractive index due to the density changed to the higher region.

### COMPARATIVE EXAMPLE 7

A method of Comparative Example 7 was conducted for comparing the results thereof with those of Example 7. An experiment was conducted by irradiating, to the core section of the optical wave-guide, laser rays having a pulse width of 100 pico-seconds in place of 150 femto-1.5 seconds in Example 1. The Raman spectra of the irradiated portion before and after the irradiation were measured. The position of the peak showing the bonding distance between Si and O constituting the glass was unchanged.

The change the density of the core section depended on the pulse length of the ultra short pulse laser.

### EXAMPLE 8

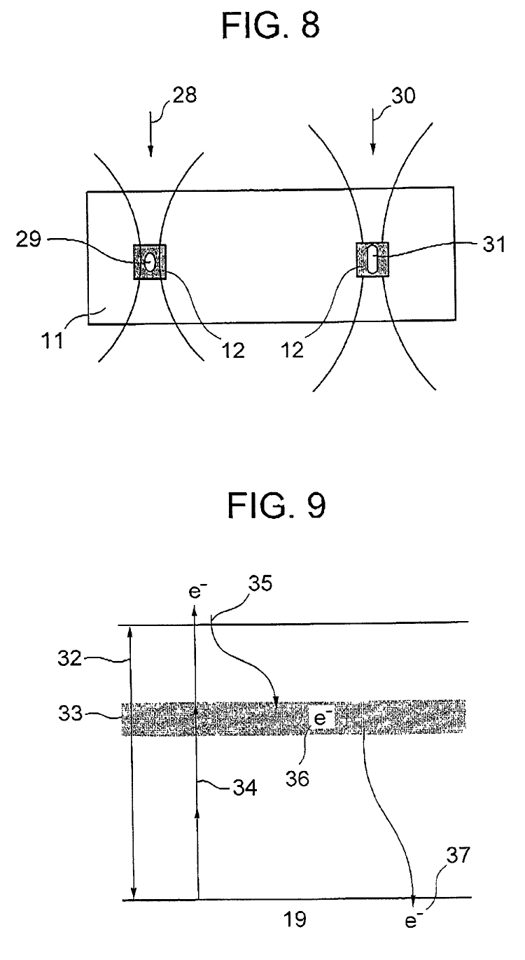

Example 8 is a concrete example of the method of modification described in claim 8. FIG. 8 is a schematic view showing the core section having the spherical hole and the core section having the oval hole in the left-hand side and the right-hand side, respectively.

In the present Example, in order to modify the refractive index of the optical wave-guide device of Example 1, laser rays having a pulse width of 150 femto-seconds, pulse energy of 0.5 μJ, a pulse repetition frequency of 1 kHz and a wavelength of 400 nm emitted from a Ti-sapphire laser were used.

The laser rays were irradiated at a time without being scanned such that the focal point was centered on the core section of the optical wave-guide by collecting the rays by using an objective lens of 100 magnifications.

As s result, as shown in FIG. 8, the spherical hole 29 having a diameter of 300 nim was formed in the core.

A similar experiment was conducted by using ultra short pulse laser rays 30 having a wavelength of 400 nm focused by an objective lens of 20 magnifications. As s result, the oval hole 31 having a width of 250 nm and a length of 75 μm just penetrating the core section.

After the specimen was polished to the portion where the refractive index was modified, the surface thereof was observed with an inter-atomic microscope. The modified portion was hollow, and the refractive index of the modified portion was 1.0.

The permeation loss of the optical wave-length after the modification was scarcely changed from that before the modification.

The energy densities of the threshold value for forming the holes in the core section of the optical wave-guide by irradiating the laser rays were changed by the pulse width or the wavelength. An experiment for modifying the refractive index was conducted similarly to that shown in FIG. 8 by changing the two parameters.

As a result, the hole could be formed in the core section similarly to the case of FIG. 8 by establishing the pulse width of 30 pico-seconds or less and the wavelength of 349 nm or more, thereby optimizing the energy density of the pulse.

The pulse width in the experiment was 50 femto-seconds at the lowest, and the pulse shorter than that could modify the refractive index.

The wavelength in the experiment was 1550 nm at the longest, and the wavelength longer than that could modify the refractive index. The pulse repetition in the experiment was all 1 kHz, and the shutter could be hardly established for taking out a single pulse in the rapider repetition. A single pulse could be easily taken out at the pulse repetition of 1 kHz or less.

### COMPARATIVE EXAMPLE 8

A method of Comparative Example 8 was conducted for comparing the results thereof with those of Example 8. An experiment was conducted by establishing the pulse energy at 1. 5 μJ while using an objective lens of 100 magnifications the same as Example 8. Several spherical holes were successively formed including in the clad section before the focused region of the laser rays. The permeation loss of the optical wave-guide after the modification of the refractive index was reduced by 2%.

Then, an experiment for modifying the refractive index was conducted similarly to Example 1 by changing the three parameters including the pulse width, the wavelength and the laser energy. In case of the pulse width of 30 pico-seconds or more, the dielectric destruction took place before the formation of the hole even if the other parameters were optimized.

The comparison between the Example 8 and Comparative Example 8 revealed that the pulse energy between 0.25 and 1.5 μJ was necessary for modifying the refractive index by forming the holes under the conditions of the pulse width of 150 femto-seconds, the pulse repetition frequency of 1 kHz and the wavelength of 400 nm.

In case of the laser rays having the pulse width of 30 pico-seconds or more, the holes could be formed even if the other parameters were optimized.

### EXAMPLE 9

FIG. 9 is a band-gap diagram for illustrating a defective band.

A defection was generated in the vicinity of a hole when ultra short pulse laser rays focused by using an objective lens of 100 magnifications similarly to Example 8 were irradiated to a core section of an optical wave-guide prepared by doping silica glass with GeO₂, and the result of the spectrum measurement revealed that, as shown in FIG. 9, a further defective band 33 was generated in the band-gap 23 of the core material.

A free electron 35 generated by three photon absorption 34 of rays having a wavelength of 400 nm was trapped in the defective band 33, and the trapped electron 36 took place the change of the refractive index.

However, after the change of the refractive index, when the optical wave-guide device was heated for one hour at 200° C., the trapped electron was relaxed to a valence band. A relaxed electron 37 was shown in FIG. 9.

The refractive index change by color center disappeared by the thermal treatment, and only the refractive index due to the density change of the core material remained. The optical wave-guide device after the thermal treatment had the excellent reliability to temperature change, and the device characteristics did not change in a temperature range between 0 and 100° C.

### COMPARATIVE EXAMPLE 9

A method of Comparative Example 9 was conducted for comparing the results thereof with those of Example 9. An experiment was conducted under the same conditions as those of Example 9 except that the device was maintained at temperature of 80° C. or more for evaluating reliability to temperature change of a device treated with no heat, and the optical path length was changed. It was estimated that the electron thermally trapped in the defective band was relaxed, thereby changing the refractive index.

The comparison between the Example 9 and Comparative Example 9 revealed that the reliability to the higher temperature use of the optical wave-guide device was improved by thermally treating the optical wave-guide device having the modified refractive index. The preferable thermal treatment conditions includes a temperature between 200 and 800° C. , and a period of time between 30 minutes and one hour.

Embodiment of Apparatus for Modifying Refractive Index

### EXAMPLE 10

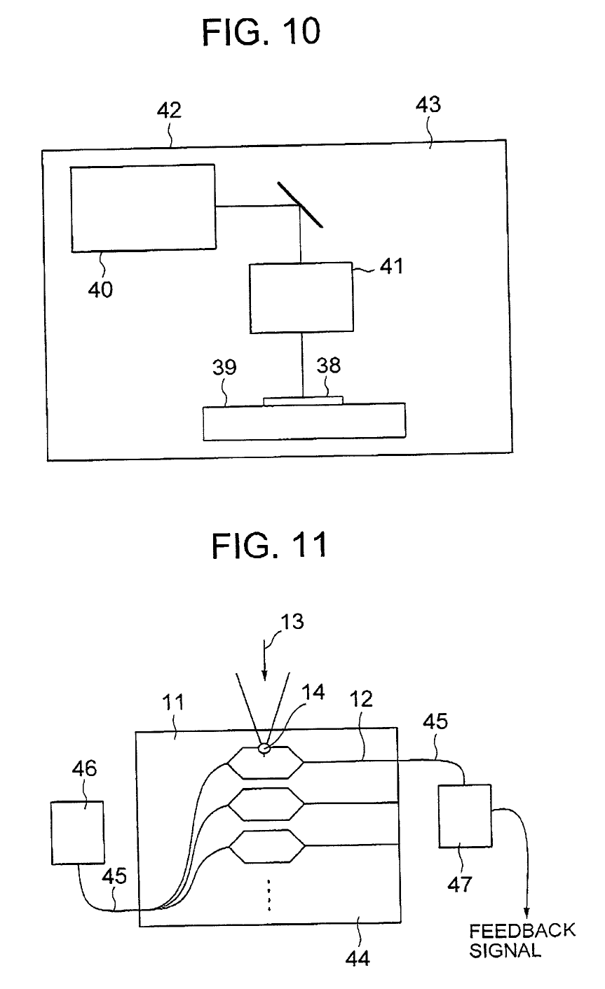

FIG. 10 is a schematic view showing configuration of the apparatus for modifying the refractive index of the present invention.

The apparatus 43 for modifying the refractive index includes, as shown in FIG. 10, a movable stage section 39 for holding and moving an optical wave-guide device 38 in X-axis, Y-axis and Z-axis directions, a pulse laser apparatus section 40 irradiating pulse rays having a pulse width of 30 pico-seconds or less, a ray-gathering section 41 for guiding the laser rays from the pulse laser apparatus section 40 to the core section of the optical wave-guide device 38 and irradiating the core section, and a chamber 42 for mounting the movable stage section 39, the pulse laser apparatus section 40, and the ray-gathering section 41.

The movable stage section 39 moves in each of the X-axis, the Y-axis and the Z-axis directions at a maximum speed of 100 mm/s and positioned the optical wave-guide device 38 at an error of ±0.1 μm. The optical system including the pulse laser apparatus section 40 and the ray-gathering section 41 enables the gathering and the irradiation of the ultra short pulse laser rays required for conducting the method of the modification described in claims 1 to 9.

Since the apparatus 43 for modifying the refractive index mounts and fixes the movable stage section 39, the pulse laser apparatus section 40, and the ray-gathering section 41 in the single chamber 42, the external vibration hardly affects the interior of the chamber 42, and the laser beams can be precisely scanned along the core section of the target optical wave-guide.

The ray propagation loss of the optical wave-guide after the modification of the refractive index of the core section was performed by using the apparatus 43 for modifying the refractive index was 0.05 dB (1%) which was scarcely changed from that before the modification.

### COMPARATIVE EXAMPLE 10

The modification of a refractive index was conducted by using an apparatus for modifying a refractive index of Comparative Example 10 for comparing the results thereof with those of Example 10. The apparatus for modifying the refractive index of Comparative Example 10 has the same configuration as that of the apparatus for modifying the refractive index of Example 10 except that the movable stage section 39, the pulse laser apparatus section 30 and the ray-gathering section 41 are no fixed to the chamber 42.

The modification of the refractive index was attempted by using the apparatus for modifying the refractive index of Comparative Example 10 under the conditions the same as those of Example 10. The vibration of the laser beams was generated, and the modified portion was deviated when the laser beam was scanned. The ray propagation loss of the optical wave-guide after the modification of the refractive index was 0.2 dB (about 5%) which was five time that of Example 5.

### EXAMPLE 11

FIG. 11 is a schematic view showing configuration of a Mach-Zender-type interference filter 44 including a clad section having a silica glass substrate 11 and a core section 12 made of silica glass having a width of 7 μm doped with GeO₂.

The interference filter 44 includes a plurality of interferometers, and rays propagating on a single fiber and having wavelengths at which the strengths are increased by each of the interferometers are branched to be output to each of the optical wave-guides.

The optical path lengths of each of the interferometers were adjusted such that rays having specified wavelengths were interfered by bonding optical fibers 45 to the input and output surfaces of the optical wave-guide device in advance and modifying the refractive index of the core section of each of the interferometers by using the apparatus 43 for modifying the refractive index 43.

During the adjustment of the optical path length, 11 kinds of the rays emitted from a multi-wavelength light source 46 and having wavelengths between 1.550 and 1.558 μm and an interval of 0.8 nm were input to the interferometers through optical fibers. Laser rays were irradiated while signals rays output from each of the branched interferometers were monitored by using a spectrum analyzer 47.

The system was configured by feed-backing the signal of the spectrum analyzer to the shutter of the pulse laser apparatus section 40 of the apparatus 43 for modifying the refractive index such that when the output strength of the monitored signal ray reached to the maximum value, the scanning and the irradiation of the laser rays were automatically finished.

The irradiation conditions were the same as those of Example 1, and the laser rays 13 having a pulse width of 150 femto-seconds were scanned at pulse energy of 0.05 μm along the core section at a scanning speed of 1 mm/s.

As a result, the refractive index could be modified to the optimum value within 3 seconds for each of the optical wave-guides, and the ray having the specified wavelength could be output from the branched optical wave-guide. The oil-matched bonding between the optical wave-guide of the output side and the optical fiber could easily make a bonding with an optical wave-guide succeedingly evaluated. A period of time required for modifying the refractive indices of all the 11 interferometers to the optimum values was about 5 minutes. The oil matching refers to the bonding in which the space between the fiber and the optical wave-guide is filled with oil having a refractive index substantially same as that of glass, thereby removing a loss.

The optical wave-guide loss was estimated from the sum of the strengths of the rays output from the branched optical wave-guides. The value was 0.1 dB (about 2%) or less, and the optical wave-guide loss was small.

### COMPARATIVE EXAMPLE 11

The modification of a refractive index was conducted, for comparing the results thereof with those of Example 11, by modifying the refractive index without guiding the signal rays under the same conditions as those of Example 11 and thereafter connecting optical fibers for evaluating the characteristics of each of the interferometers.

In Comparative Example 11, about 10 minutes were required for each of the interferometers because not less than two modifications were necessary for adjusting one interferometer, and about 100 minutes were required for modifying the refractive indices while evaluating the characteristics of all the optical wave-guides.

The comparison between Example 11 and Comparison Example 11 emphasizes the advantage of modifying the refractive index while guiding the signal rays.

### EXAMPLE 12

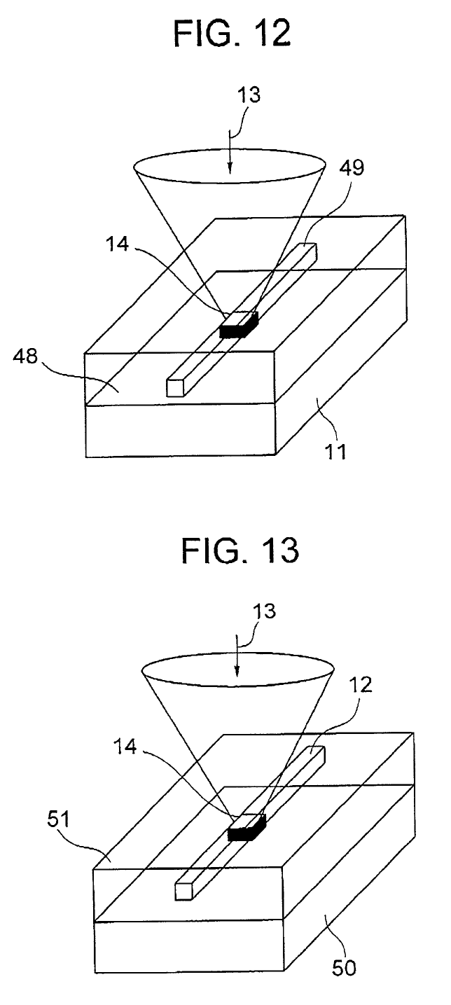

FIG. 12 is a perspective view showing configuration of an optical wave-guide device including a polymer thin film 48 made of polymethylmethacrylate (PMMA) having a refractive index of 1.500 formed on a silica glass substrate 11, and a core section 49, formed in the polymer thin film 48, having 7×7 μm of an optical wave-guide made of a polymer of a PMMA derivative having a refractive index larger than that of the above polymer thin film 48 by 0.001.

The laser rays having a pulse width of 150 femto-seconds were irradiated to the core section similarly to Example 1, and the scanning was conducted for a length of 1 mm at a scanning speed of 1 mm/s. The pulse energy was 0.02 μJ.

As a result, the density of the polymer of the core section was increased due to the change of the polymerization rate, and the change of the refractive index per unit scanning distance was 0.0015 mm. In this manner, the refractive index could be modified.

FIG. 13 is a perspective view showing configuration of an optical wave-guide device including a polymer thin film 51 having a thickness of 20 μm formed on a silicon substrate 50, and a core section 12, formed in the polymer thin film 51, having 7×7 μm of silica glass doped with GeO₂.

The refractive index modification could be conducted similarly to Example 1 by focusing and scanning ultra short pulse laser rays 13 to the core section of the optical wave-guide by using an objective lens of 100 magnifications.

The refractive index of the core section could be modified without damaging the silicon substrate provided that the core section was formed at the position higher than 5 μm from the silicon substrate. The same relation as that of FIG. 5 was obtained between the scanning distance or the number of the scanning and the change of the optical path length.

### EXAMPLE 14

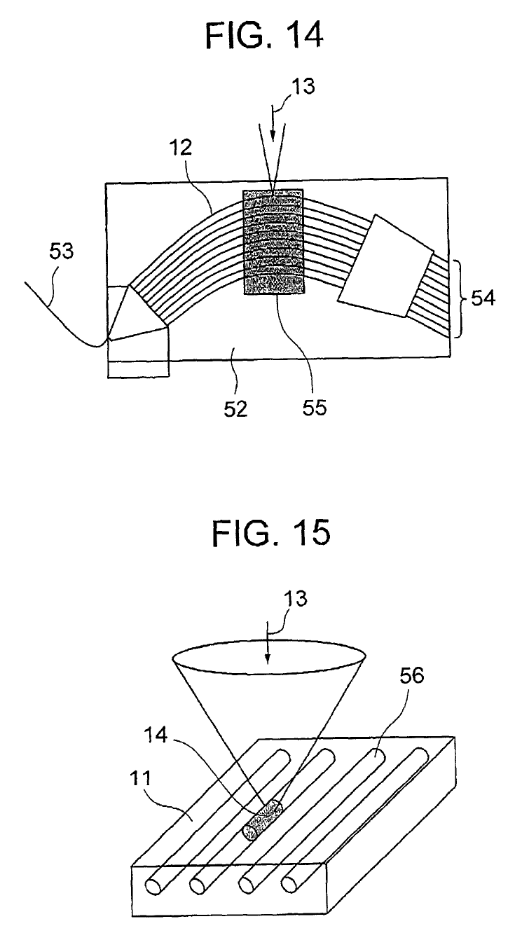

FIG. 14 is a perspective view showing configuration of an optical wave-guide device 52 for dividing a wavelength including a silica glass thin film 51 having a thickness of about 20 μm formed on silicon shown in FIG. 13, and a core section 12, formed in the silica glass thin film 51, having a width of 7 μm made of silica glass doped with GeO₂.

In the optical wave-guide device 52, an output 54 was obtained which was divided into rays having the respective wavelengths at an interval of 0.4 nm among rays 53 having multi-wavelengths from 1.550 μm to 1.554 μm transmitting in a single fiber. The interval between the adjacent optical wave-guides at the broadest was quite narrow, that is, 20 μm.

The modification of the refractive index was conducted by using the laser rays having the same conditions as those of Example 1 and the apparatus 43 for modifying the refractive index having the feed-back function such that the ray having the specified wavelength from each of the branched optical wave-lengths had the maximum output by means of monitoring the permeated rays. Even when the optical wave-guide interval was 20 μm or less, the dimensions of the region where the refractive index changed could be adjusted such that the diameter of the focused beam was modified to 7 μm the same as that of the optical wave-length by using an objective lens of 100 magnifications.

As a result, the refractive indices of each of the optical wave-guides could be adjusted to those for providing the specified performance without providing an influence to other optical wave-guides.

### EXAMPLE 15

As described in the prior art, the optical wave-guide formed by scanning the ultra short pulse laser rays in the glass is not required to be doped with GeO₂ in the glass. FIG. 15 is a perspective view showing configuration of the optical wave-guide device formed in the silica glass in accordance with the above process.

An experiment similar to that of Example 1 was attempted in order to modify a refractive index of a core section 56 of an optical wave-guide directly depicted by the ultra short pulse laser rays. The refractive index could be modified similarly to the case where the silica glass doped with the GeO₂ was used.

The volume matching between the refractive index modification of the core section directly depicted by the ultra short pulse laser rays and the portion where the refractive index were quite excellent, and the loss of the guided rays due to the refractive index modification was hardly observed. The “volume matching” refers to a degree what an extent the sectional shape of the optical wave-guide and that of the region where the refractive index changes are matched.

### EXAMPLE 16

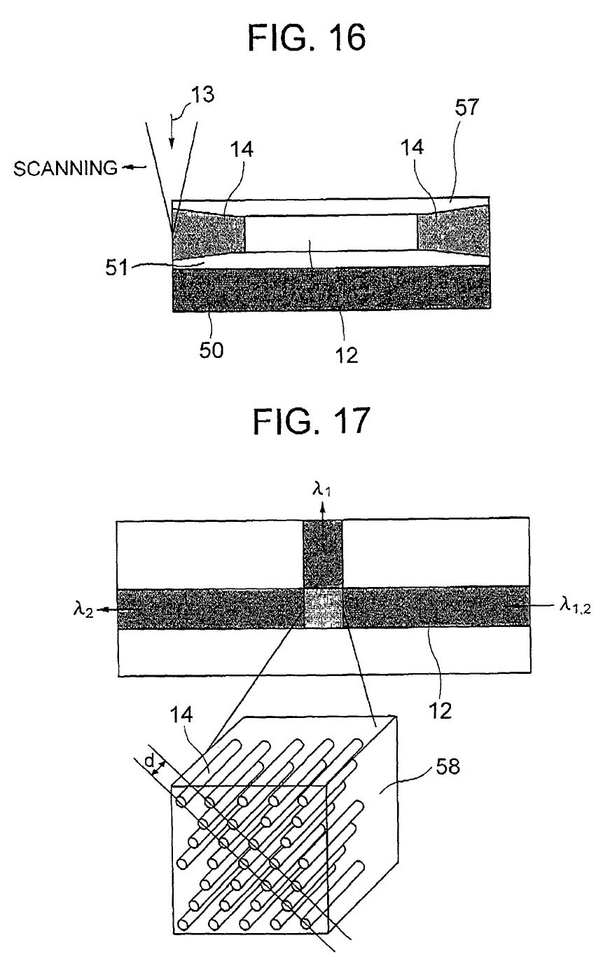

FIG. 16 is a sectional view showing an optical wave-guide device including a silica glass thin film 51 formed on a silicon substrate 50, and a core section 12, formed in the silica glass thin film 51, having a geometrical element length of 20 mm doped with GeO₂. The core section was 5 μm square.

As shown in FIGS. 3 and 4, the region where the refractive index changes by using the ultra short pulse laser 23 can be changed to a region including part of the core section and the periphery of the core section by adjusting the focusing lens and the input laser power.

As shown in FIG. 16, the length of 10 mm along the optical wave-guide from the end surface where the signal rays were input or output was scanned at the scanning speed of 1 mm/s and using the laser rays the same as those of Example as the light source while the average power of the laser rays focused by an objective lens of 50 magnifications and irradiated was changed from 30 mW to 10 mW.

As a result, as shown in FIG. 16, the refractive index of the core section and the region around the core section was modified. The core diameter of the input and output surface was 8 μm and that of the end of the region where the refractive index was modified was about 5 μm. These were substantially same as that of the core diameter of the optical wave-guide.

The ray propagation loss of the optical wave-guide was measured to be 0.1 dB (about 2%) or less after the optical fiber having a core size of 7 μm was connected to a the refractive index modified portion 14 acting as a spot size converting optical wave-guide 57.

The optical fiber and the optical wave-guide having the different core diameters could be bonded without a loss by modifying the core section of the input and output surface to the tapered surface.

### EXAMPLE 17

FIG. 17 is a top plan view showing a T-shaped branched optical wave-guide device using grating of holes in which a core section 12 of an optical wave-guide doped with GeO₂ is formed in silica glass thin film 51 formed on a silicon substrate, and an enlarged perspective view shows a portion where a refractive index is modified.

In the present Example, an oval or cylindrical hole having a diameter of 250 nm and a length of 7 μm was formed by focusing, to a T-shaped branch, the laser rays of 400 nm and 1 kHz used in Example 1 by using an objective lens of 20 magnifications. The holes are, as shown in the bottom part of FIG. 17, formed to satisfy the Bragg's equation (λ=2 d sin θ).

The wavelength (λ) in the core section was A In, and “n” is 1.475 which is the refractive index of the core section. If the input wavelengths λ_{1,} and λ₂ are presumed to be 1.550 μm and 1.300 μm, respectively, a constant “d” for diffracting only the ray having the wavelength of 1.550 μm is calculated by using a below equation (2).

d=λ/(n.2 sin 45°)=743 nm (2)

Then, the distance “d” shown in the lower drawing in FIG. 17 was established to be 743 nm, and the bar-like holes were arranged in an interval of 500 nm. When the rays having the above two wavelengths were input, 15% of the signal ray of 1.550 μm was diffracted to a vertical direction by the grating and came out from the branched optical wave-guide. On the other hand, the permeation loss of the ray having the wavelength of 1.300 μm was within 1%.

By adjusting the interval of “d” to 623 nm, the ray having the wavelength of 1.300 μm could be diffracted to a vertical direction and output from the branched optical wave-guide, and the diffraction efficiency was 15%.

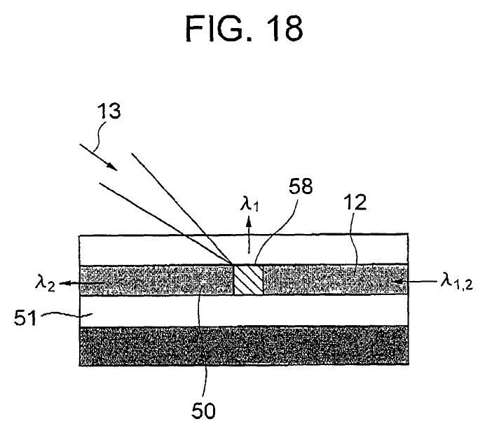

FIG. 18 is a side elevation view showing a section of optical wave-guide having a core section doped with GeO₂ in a silica glass thin film 51 on a silicon substrate 50. The laser rays 13 used for forming the grating in FIG. 17 were diagonally irradiated on the core section, thereby forming holes slanted at 45°. The interval of the holes was established such that the ray having the wavelength of 1.550 μm was diffracted.

When the rays having the wavelengths of 1.550 μm and 1.300 μm were transmitted, 10% of the ray of 1.550 μm was upward diffracted from the core section 12, permeated the clad section and came out from the surface of the optical wave-guide device. On the other hand, in connection with the signal ray of 1.300 μm, 1% or less thereof was upward diffracted from the core section 12, permeated the clad section and came out from the surface of the optical wave-guide device.

In an alternative Example, the core section for guiding the rays and doped with GeO₂ in the glass optical wave-guide device preferably includes a planar slub wave-guide which is subjected to the refractive index modification.

In a further Example, the core section of at least one of the optical wave-guide and a section of coupling rays of a coupler is preferably subjected to the refractive index modification.

In a still further Example, the optical wave-guide device preferably includes an array wave guide grating for dividing the multiplexed rays used for WDM optical telecommunication and binding the divided rays, and the refractive index is modified such that the ray having a specified wavelength is coupled to the optical wave-guide.

In a yet further Example, the optical wave-guide device preferably includes a fiber grating for diffracting a ray having a specified wavelength and the refractive index of the grating is modified by the specified wavelength.

In a still further Example, the surface shape of the optical wave-guide irradiated with the laser rays is preferably convex to act as a lens to focus the irradiated rays to the core section of the laser wave-guide.

Since the above embodiments are described only for examples, the present invention is not limited to the above embodiments and various modifications or alterations can be easily made therefrom by those skilled in the art without departing from the scope of the present invention.

What is claimed is:

1. A method for modifying a refractive index of an optical wave-guide device having a core section and a clad section, said method comprising the steps of;
irradiating ultra short pulse laser rays having a pulse width not more than 30 pico-seconds to at least one of the core section and the clad section.

2. The method as defined in claim 1, wherein the ultra short pulse laser rays have photon energy lower than half of band-gap energy of a material of the clad section.

3. The method as defined in claim 1, wherein the ultra short pulse laser rays are irradiated to the core section including a periphery thereof, only to the core section or to a part of the core section, thereby changing the refractive index of the core section or the part of the core section without changing the refractive index of the clad section.

4. The method as defined in claim 1, wherein the ultra short pulse laser rays are focused to the core section including a periphery thereof, thereby changing the refractive index of the periphery of the core section together with the refractive index of the core section.

5. The method as defined in claim 1, wherein the ultra short pulse laser rays are irradiated, while scanned along the core section at least one time, to the core section of the optical wave-guide to modify the refractive index thereof.

6. The method as defined in claim 1, wherein the core section includes a plurality of stacked layers or a three-dimensional structure, and the ultra short pulse laser rays are irradiated to the bottom part of the core section to modify the refractive index thereof without changing the refractive index of the top part of the core section.

7. The method as defined in claim 1, wherein the refractive index of the irradiated part is elevated by increasing a density of the irradiated part.

8. The method as defined in claim 1, wherein the refractive index of the irradiated part is reduced by decreasing a density of the irradiated part or producing holes therein.

9. The method as defined in claim 1, wherein the optical wave-guide device is thermally treated after the modification.

10. The method as defined in claim 1, wherein the laser rays having a power density of saturating the change of the refractive index of the core section are irradiated.

11. The method as defined in claim 1, wherein the laser rays are irradiated to the core section for heating the core section as well as for modifying the refractive index of the core section, thereby unnecessitating thermal treatment.

12. The method as defined in claim 1, wherein when a surface of the optical wave-guide device is uneven, the laser rays are irradiated after liquid or gelled material having a refractive index substantial same as that of the clad section is applied to the surface, and a transparent material through which the laser rays permeate is applied thereon to flatten the surface.

13. The method as defined in claim 1, wherein the shape of the core section transmitting the rays is changed to have a taper.

14. The method as defined in claim 1, wherein the core section includes a grating for diffracting rays transmitting in the core section to any direction.

15. The method as defined in claim 1, wherein the core section for guiding the rays and doped with GeO₂ in the glass optical wave-guide device includes a planar slub wave-guide which is subjected to the refractive index modification.

16. The method as defined in claim 1, wherein the core section of at least one of the optical wave-guide and a section of coupling rays of a coupler is subjected to the refractive index modification.

17. The method as defined in claim 1, wherein the optical wave-guide device includes an array wave guide grating for dividing the multiplexed rays used for WDM optical telecommunication and binding the divided rays, and the refractive index is modified such that the ray having a specified wavelength is coupled to the optical wave-guide.

18. The method as defined in claim 1, wherein the optical wave-guide device includes a fiber grating for diffracting a ray having a specified wavelength and the refractive index of the grating is modified by the specified wavelength.

19. An apparatus for modifying a refractive index of an optical wave-guide device:
a stage section for holding and moving the optical wave-guide device in “x”, “y” and “z” directions mounted in a chamber;
a lasing section for emitting laser rays having a pulse width not more than 30 pico-seconds used for modifying the refractive index of a core section mounted in the chamber; and
an optical system section for irradiating the laser rays lased in the lasing section on the core section of the optical wave-guide device in “x”, “y” and “z” directions mounted in the chamber.

20. The apparatus as defined in claim 19, wherein the apparatus includes a function of irradiating ultra short pulse laser rays to the core section of the optical wave-guide device for modifying the refractive index while the rays are guided after an optical fiber is bonded to an input and output surface of an optical wave-guide device for modifying the refractive index, and a function of feed-backing outputs from the optical wave-guide device to irradiation conditions of the laser rays for obtaining the change of the refractive index of the target core section.

21. The apparatus as defined in claim 19, wherein the core section and the clad section of the optical wave-guide device are made of amorphous or a polymer molecule, and the refractive index of the core section of the device was modified.

22. The apparatus as defined in claim 19, wherein the optical wave-guide device is formed in a glass thin film having a thickness of 100 μm or less overlying a silicon substrate, and the refractive index of the core section of the optical wave-guide is modified.

23. The apparatus as defined in claim 19, wherein the optical wave-guide device includes a plurality of optical wave-guides having an interval of 30 μm or less, and the core sections of the plurality of the optical wave-guides are individually modified.

24. The apparatus as defined in claim 19, wherein the core section for guiding the rays in the optical wave-guide device containing glass-based material includes no GeO₂.

25. The apparatus as defined in claim 19, wherein a surface shape of the optical wave-guide irradiated with the laser rays is convex to act as a lens to focus the irradiated rays to the core section of the laser wave-guide.
